(19) United States
(12) Patent Application Publication
(10) Pub. No.: US 2007/0221736 A1
(43) Pub. Date: Sep. 27, 2007

(54) Tamper-evident label

(76) Inventor: William T. Bailey, Stafford, CT (US)

Correspondence Address: MCCORMICK, PAULDING & HUBER LLP, CITY PLACE II, 185 ASYLUM STREET, HARTFORD, CT, 06103, US

(21) Appl. No.: 11/725,685

(22) Filed: Mar. 19, 2007

Related U.S. Application Data
(60) Provisional application No. 60/783,271, filed on Mar. 17, 2006.

(51) Int. Cl. G06K 19/00; G06K 19/06

(52) U.S. Cl. 235/487; 235/494

(57) ABSTRACT

A tamper-evident label includes a label body having a bar code area, and having tamper indicating means located in at least a portion of the bar code area. The tamper indicating means preferably includes a part of the label body with weakening formed therein, and at least one substantially diamond-shaped area is defined by the weakening. A method of generating a temper evident label includes identifying an area of a label body as a bar code area, and forming tamper indicating means on the label body such that at least a portion of the tamper indicating means is located within the bar code area. A label assembly includes a label body having a bar code area and tamper indicating means located in at least a portion of the bar code area, and a backing having a coating of release material, the label body being releasably attached to the backing.

### CROSS-REFERENCE TO RELATED APPLICATION

The present invention claims the benefit of U.S. Provisional Application No. 60/783,271, filed on Mar. 17, 2006, the contents of which application are herein incorporated by reference in their entirety.

### FIELD OF THE INVENTION

The present invention relates generally to adhesive labels, and particularly to pressure sensitive labels with bar code areas.

### BACKGROUND OF THE INVENTION

The use of labels with bar codes is ubiquitous in most commercial enterprises, including specialty stores, department stores, discount warehouses, and supermarkets. The use of such labels in connection with bar code scanning devices allows for the relatively easy and efficient tracking of inventory and sales, as well as facilitating consumer purchases. Many stores, especially supermarkets, even have “self-checkout” lines where the consumers, themselves, scan the labels during the purchase process.

Even with bar codes, however, every commercial enterprise faces the risk of “shrinkage,” where inventory decreases at a rate faster than it is being purchased. The most basic activity that accounts for shrinkage is simple shoplifting, where an unscrupulous individual attempts to conceal one or more items and leave the commercial premises without paying anything. Many commercial enterprises, especially those with very large sales volumes, have become particularly adept at detecting and deterring this type of wholesale theft. For instance, the use of cameras and/or theft deterrent devices (which must be de-activated upon purchase) is widespread.

More sophisticated shoplifters attempted to circumvent these precautions by appearing to purchase the desired goods, while still providing themselves with a substantial discount. Typically, this was done by removing the label from the expensive, desired product and substituting a label from a much less expensive product. Illegal actions of this type were particularly common in the specialty foods and meat departments of supermarkets.

For example, an individual wished to have filet mignon but did not want to pay the high price. The same individual noticed that 70-percent lean ground beef sold for substantially less. Hoping to save the difference, the individual would peel off the label from the filet and replace it with the label from the ground beef. Unless the cashier was paying close attention, which could be difficult if the spuriously-labeled filet was part of a larger purchase, the ruse often succeeded. At a self-checkout, the ruse was virtually certain to succeed.

Tamper-evident labels were designed to thwart this type of activity. Such labels featured a pattern of scoring (typically, hatches, circles, or rectangles) which resulted in mutilation of the scored areas of the label if it was peeled off after the initial application. The scoring was most often located in the area of the label upon which the price was printed. Ideally, the mutilated scoring would more readily alert the employees at the point of purchase that something was amiss.

In the past, while the scoring pattern has been located in various locations on the label, it has not been located in the bar code area. The reason for this was that the scoring was likely to interfere with the accurate scanning of the bar code, even if intact and un-mutilated (as would be the case with a legitimate purchase). Since the scoring was not placed in the bar code area, a label with mutilated scoring in other areas would still scan properly if not noticed by an employee. Additionally, many sophisticated shoplifters learned to remove only the bar code from the less expensive item and superimpose that bar code over the bar code on the more expensive item. Razor blades were often used to facilitate the process. Accordingly, there would be no mutilated label to alert employees to the deception, and the potential theft would only be detected if a cashier, or other point of purchase personnel, noticed the discrepancy between the price on the label and the scanned price. Of course, with a self-checkout arrangement, even this last line-of-defense was lacking.

Shrinkage in supermarkets alone results in millions of dollars in lost revenues each year. Total shrinkage throughout commercial enterprises is obviously much higher. The increased expenses resulting from shrinkage translate into negatives like higher costs for honest consumers, lost economic opportunities and slower growth, lower wages, and/or loss of jobs.

It can be seen that there exists a need for a tamper-evident label, which provides for mutilation of the bar code during removal of the label after initial application, while ensuring that the bar code of an intact label will scan accurately.

### SUMMARY OF THE INVENTION

In view of the foregoing, it is an object of the present invention to provide a tamper-evident label with tamper indicating means in the bar code area designed to ensure mutilation of the scored area in case of tampering, while still allowing an intact bar code to scan properly.

According to an embodiment of the present invention, a tamper-evident label includes a label body having a bar code area, and having tamper indicating means located in at least a portion of the bar code area. According to an aspect of the present invention, the tamper indicating means includes a part of the label body with weakening formed therein. According to another aspect of the present invention, at least one substantially diamond-shaped area is defined by the weakening.

According to another embodiment of the present invention, a method of generating a temper evident label includes identifying an area of a label body as a bar code area, and forming tamper indicating means on the label body such that at least a portion of the tamper indicating means is located within the bar code area.

According to a further embodiment of the present invention, a label assembly includes a label body having a bar code area and tamper indicating means located in at least a portion of the bar code area, and a backing having a coating of release material, the label body being releasably attached to the backing.

These and other objects and features of the present invention will be better understood in view of the drawings and detailed description.

### BRIEF DESCRIPTION OF THE DRAWINGS

FIG. 1 shows a label assembly with an intact label according to an embodiment of the present invention.

FIG. 2 shows the label of FIG. 1, after tampering, according to an embodiment of the present invention.

### DETAILED DESCRIPTION

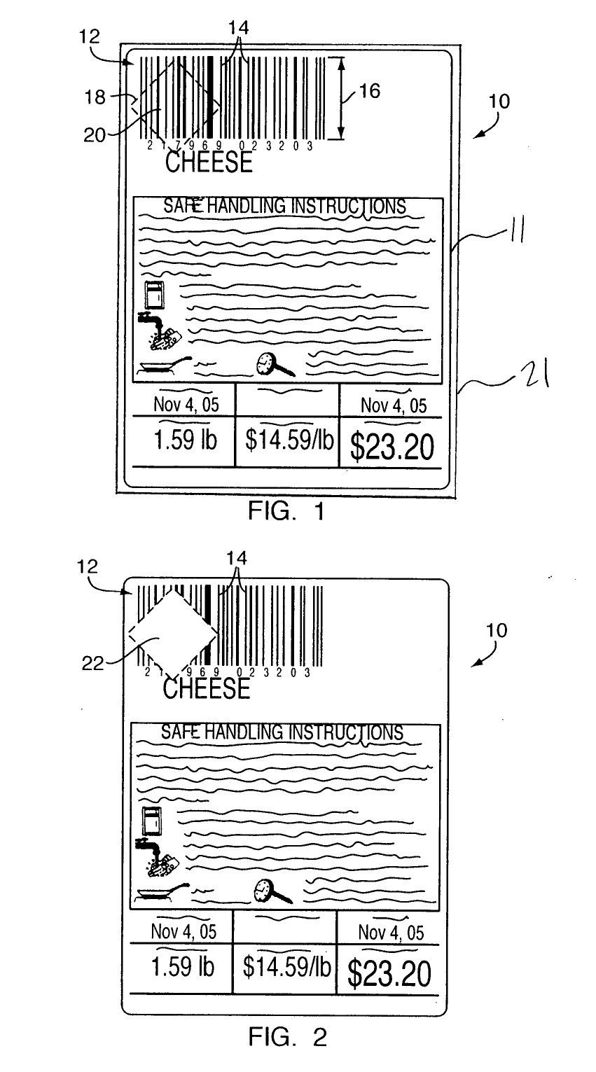

Referring to FIG. 1, a label 10 includes a label body 11. The label body 11 is provided with a bar code area, indicated generally at 12. In the bar code area 12, a bar code is printed in the form of a plurality of bars 14 having an overall height 16, the bars 14 also having and a varying width and spacing. Weakening 18 is formed in the bar code area 12 to define a diamond-shaped area 20. In the embodiment shown, the part of the label body 11 with weakening formed therein constitutes tamper indicating means. It can be seen that the weakening 18, at most, intersects a given bar 14 in two discrete points, thus not creating any discontinuities extending along an extended portion of the height of any one bar 14. Additionally, the weakening 18 does not intersect any two adjacent bars 14 at the same point in their overall height 16. Accordingly, in a label 10 having tamper indicating means according to present invention, interference with an electronic bar code scanner as it scans across the bar code is minimized, as the tamper indicating means does not create any discontinuities or alterations covering a substantial portion of the overall height of any bar 14 or the interstice between adjacent bars 14, or extending between multiple adjacent bars 14 at the same point in their overall height.

Weakening which is substantially horizontal, vertical, or curved relative to the bars 14, by contrast, has a high likelihood of affecting the spacing between bars, the apparent width of one or more bars, and/or of creating a discontinuity that continues between several adjacent bars. Any of these undesirable effects potentially degrade the accuracy with which an electronic bar code scanner will read the bar code, and/or the ability of the bar code scanner to read that bar code, at all. To the extent that minimizing the undesirable effects associated with horizontal, vertical or curved weakening would even be possible, such minimization (if possible) would require, at least, highly precise alignment of the weakening relative to the bars of the bar code. This combination of precise printing and scoring is largely unachievable with existing equipment and industry practices (particularly, as the bar code is not typically printed on the label until after tamper indicating features are applied—as explained below), and, unlike the present invention, would significantly increase the production costs associated with such labels.

In current industry practice, many items that are frequent targets of shoplifters are specialty items packaged by a retailer and priced by weight or quantity. As the bar code encodes product and pricing information, the bar code is typically printed onto the bar code area 12 of the label 10 by the retailer. Accordingly, the label 10 of the present invention is typically supplied by a label manufacturer to the retailer with whatever tamper indicating features are to be applied to the bar code area 12 of the label 10 already applied, but without a bar code printed in the bar code area 12.

In an exemplary embodiment, the label 10 is a pressure sensitive label, and the label is distributed, to the retailer, or other commercial enterprise, as an assembly together with a backing 21, to which the label body 11 is releasably attached. The backing 21 is preferably treated with a release material (a material having a low affinity to the pressure sensitive, or other, adhesive on the label body 11 to allow the label body 11 be removed from the backing and initially applied to a product without mutilation of the tamper indicating means. In use, the label body is printed with a bar code in the bar code area 12, as well as with other appropriate information printed elsewhere on the label body 11, by a label printer. The label body 11 is then removed from the backing 21 and initially applied to a product. During regular use, a consumer selects the labeled product, the bar code is scanned, and the consumer purchases the product at the appropriate price.

During an attempted pre-sale removal of the label 10, the diamond-shaped area 20 breaks away from the rest of label body 11, leaving an open area 22 (as seen in FIG. 2). As a result, the bar code will no longer scan properly, and it would be extremely difficult and time-consuming to then try and remove the diamond-shaped area 20 from the product and re-insert it within the open area 22 with sufficient precision to allow the bar code to scan properly, resulting in an increased likelihood of the detection and prevention of the attempted deception.

Those skilled in the art will appreciate that the present invention is not limited to the embodiments herein shown and described, but that various adaptations and modifications are possible within the scope of the present invention.

For instance, the label 10 can be any type of adhesive label, and not just a pressure sensitive label, and can be applied to any type of product. For example, the present invention can be applied to various labels manufactured from various stocks, such as paper, litho, latex, foil, vinyl, and thermal material. Also, labels applying other types of adhesives can also be employed, including thermosetting adhesives, UV and/or light curing adhesives, water-activated and/or drying adhesives, and contact adhesives.

Additionally, the present invention is equally applicable to labels of any size and/or shape, although the following manufacturer's Scale label layouts are typical: Berkel, Bizerba, Cas, Digi, ESI, Exact, Franklin, Global, Hobart, Ishida, Kubota, NCI, TEC, Toledo, and Weldotron.

The bar code area refers to the area of the label 10 where, pursuant to the particular label layout, the bar code is to be printed onto the label. Thus, a bar code area is identifiable for any given label layout designed to accommodate a bar code, even if the bar code has not yet been printed in the bar code area. Furthermore, for any given label layout with a predetermined bar code area, the orientation of the bars of the bar code, such as the direction in which the overall heights 16 of the bars will commonly extend and the direction in which adjacent bars in a series will be arranged adjacent to each other, is also discernible prior to actually printing the bar code in the bar code area. The present invention, thus, includes labels not yet printed with a bar code, as well as labels printed with a bar code. Furthermore, the present invention extends to printing the bar code before, during or after the application of the tamper indicating means to the label.

The diamond-shaped weakening 18, shown within the part of label body 11 forming the tamper indicating means, is preferred for a tamper indicating means, because while minimizing interference with the operation of electronic bar code scanners (as described above), the scoring will result in a mutilated area regardless of the direction from which a potential shoplifter attempts to remove the label. “V”-shaped scoring, for instance, can also minimize interference with bar code scanning, but may not as reliably result in the desired mutilation if the label is peeled from the open end of the “V.”

However, the present invention can also utilize “V” shaped scoring, as well as other scoring shapes and designs and/or combinations of shapes and/or designs, incorporating the principles outlined herein for non-interference with electronic scanning of the bar code, such as diagonal scoring. Other tamper indicating features may be formed on the label body 11 in any number and, in addition to the bar code area 12, may be located in other areas of the label such as a price area.

The weakening 18 is preferably applied during manufacturing of the label 10 by scoring the label 10 using a diamond-, or other appropriately-shaped die, though it could applied at other times, such as during printing on the label. Various sizes of diamond-, or other-shaped dies may be used to provide desired sizes of areas 20 in the bar code area 12. Preferably, the weakening creates areas, lines, and/or points along and/or at which the force required to tear the weakening is less than the force required to peel the label off after application to a product.

The dashed lines indicating the weakening 18 are illustrative only; it is not required that the weakening penetrate through the label and/or create multiple perforations through the label. The term “weakening” as used herein encompasses any means used to weaken the label body or render the label body more susceptible of mutilating during pre-sale removal from a product, including scoring, perforating, partial manual or chemical removal of material in the area of the weakening, reinforcement of the label body in adjacent areas, and/or the addition of extra/stronger adhesive.

It is preferred that any weakening formed include one or more un-weakened points of attachment to the remainder of the label body (for example, points between perforations or open spaces between opposing “V”s used to form a substantially diamond-shaped area) to facilitate further tearing and mutilation of the label adjacent to the tamper indicating means 18.

The present invention is shown with a UPC format bar code in the bar code area 12. However, those skilled in the art will appreciate that the present invention is equally applicable to other types of bar code formats, such as Code 93, Code 128, and various 2-D symbologies.

Those skilled in the art will appreciate that the present invention is not limited to the embodiments described, but that various modifications, as well as adaptations for various circumstances and situations, are possible without departing from the scope of the present invention.

What is claimed is:

1. A tamper-evident label comprising:
a label body having a bar code area, and having weakening formed in at least a portion of the bar code area.

2. The label of claim 1, further including a bar code located in the bar code area.

3. The label of claim 1, wherein the bar code area is predetermined to accommodate a bar code including a plurality of bars with heights extending in a common direction, and the weakening is oriented so as to be substantially diagonal relative to the heights of the bars.

4. The label of claim 3, wherein at least one substantially diamond-shaped area is defined by the weakening.

5. The label of claim 4, wherein at least one discrete un-weakened point extends between the at least one at least one substantially diamond-shaped area and another area of the label body outside the substantially diamond-shaped area.

6. The label of claim 1, wherein the weakening is arranged such that any intersection between the weakening and any bar of a bar code, when located in the bar code area, forms only a discrete point.

7. The label of claim 6, wherein the weakening is arranged such that at most two discrete points are formed by the intersection of the weakening with any bar.

8. The label of claim 1, wherein the label is a pressure-sensitive label.

9. A tamper-evident label comprising:
a label body having a bar code area, and having tamper indicating means located in at least a portion of the bar code area.

10. The label of claim 9, further including a bar code located in the bar code area.

11. The label of claim 9, wherein the tamper indicating means includes a part of the label body with weakening formed therein.

12. The label of claim 11, wherein the bar code area is designated to accommodate a bar code formed from a series of bars each located adjacently to one another along a first direction, and the weakening located in the bar code area is oriented so as to be substantially diagonal relative to the first direction.

13. The label of claim 12, wherein at least one substantially diamond-shaped area is defined by the weakening.

14. The label of claim 13, wherein at least one discrete un-weakened point extends between the at least one substantially diamond-shaped area and another area of the label body outside the at least one substantially one diamond-shaped area.

15. The label of claim 9, wherein the label is a pressure sensitive label.

16. A method of generating a temper evident label, the method comprising the steps of:
identifying an area of a label body as a bar code area; and
forming tamper indicating means on the label body such that at least a portion of the tamper indicating means is located within the bar code area.

17. The method of claim 16, further comprising the step of forming a bar code in the bar code area.

18. The method of claim 17, wherein the step of forming a bar code in the bar code area is performed after the step of forming tamper indicating means on the label body.

19. The method of claim 16, wherein, based on the label layout, a plurality of bars forming a bar code are predetermined to be printed in the bar code area with a common orientation, and the step of forming the tamper indicating means on the label body includes scoring a part of the label body with a die such that the scoring is oriented diagonally relative to the common orientation.

20. The method of claim 19, wherein the die is used to score the label to form at least one substantially diamond-shaped area.

21. A label assembly comprising:
a label body having a bar code area and tamper indicating means located in at least a portion of the bar code area; and
a backing having a coating of release material, the label body being releasably attached to the backing.
